(19) United States
(12) Patent Application Publication
(10) Pub. No.: US 2013/0159050 A1
(43) Pub. Date: Jun. 20, 2013

(54) Methods and Systems for Managing Corporate Risk

(71) Applicant: Tailored Solutions and Consulting, Inc., Washington, DC (US)

(72) Inventors: Sean Doherty, Silver Spring, MD (US); Natalie Lehr-Lopez, Chevy Chase, MD (US); Mark Lopes, Purcelville, VA (US); Michael Princi, Westford, MA (US); Michael Rossi, Mount Airie, MD (US); Gabe Ruth, Sterling, VA (US); Patrick Murray, Fairfax, VA (US)

(73) Assignee: Tailored Solutions and Consulting, Inc., Washington, DC (US)

(21) Appl. No.: 13/692,614

(22) Filed: Dec. 3, 2012

Related U.S. Application Data
(60) Provisional application No. 61/566,093, filed on Dec. 2, 2011.

(51) Int. Cl. G06Q 10/06

(52) U.S. Cl. CPC G06Q 10/0635
USPC 705/7.28

(57) ABSTRACT

Methods and systems for facilitating transactions are disclosed. A method for identifying corporate risk, implemented on a computer system, includes obtaining corporate data on computer-readable media, the corporate data comprising at least one of internal data and external data, obtaining behavioral corporate data from the corporate data on computer-readable media, the behavioral corporate data comprising at least one event data point, obtaining data indicative of risk-creating behavior from the behavioral corporate data on computer-readable media by evaluating the corporate data against a knowledge-base of characteristic risk-creating behavior, and communicating the data indicative of risk-creating behavior to a user as threat vectors with at least one dimension, the threat vectors displayed on a graphical user interface.

This application claims the benefit of U.S. Provisional Patent Application No. 61/566,093, filed on Dec. 2, 2011, and entitled, “A quantitative method for repurposing and analyzing data generated by business systems to identify risks to corporate value and valuation,” which is incorporated herein by reference in its entirety.

### BACKGROUND

Conventional methods of assessing risks to firms' intellectual capital typically involve ad hoc and opinion-driven processes reliant on expert opinion. These consultant-based approaches, by which a third party is employed to assess policy, governance, technology and market risks, suffer from two fundamental shortcomings. First, they are opinion-based. Different consultants may render different judgments as a function of their individual background and biases. Conventional risk management methods and systems are also limited to simple system log analysis, leading firms to develop a false sense of security.

Second, consultant-based methods are not scalable. While the amount of data to be analyzed may increase over time, the cost of consulting resources increases at a faster rate. The costs and complexity attendant to traditional systems designed to protect this data may likewise increase faster, particularly as resulting geographic footprints and external partnerships increase. The discrepancies in rates of increase between the amount of data needed to be analyzed and the cost and complexity of analysis exist for several reasons. The ability of the human mind to process and identify patterns in large volumes of information of varying kinds is limited, such that an increase in data may result in a conventional specialized software tools designed to assist consultants are not designed to account for the ever-increasing scale and interdependencies between data from different parts of a firm. As a result, even the most expert and experienced consultants are forced to render impressionistic judgments that do not reflect the totality of available data. Moreover, the pool of qualified and capable consultants with the requisite experience to analyze disparate sets of information is small, such that as data grows, supply becomes more costly. These factors combine to render large-scale comprehensive risk management engagements typically very expensive and available only to the largest firms.

### SUMMARY

An exemplary method for identifying corporate risk, implemented on a computer system, may include obtaining corporate data on computer-readable media, the corporate data comprising at least one of internal data and external data, obtaining behavioral corporate data from the corporate data on computer-readable media, the behavioral corporate data comprising at least one event data point, obtaining data indicative of risk-creating behavior from the behavioral corporate data on computer-readable media by evaluating the corporate data against a knowledge-base of characteristic risk-creating behavior, and communicating the data indicative of risk-creating behavior to a user as threat vectors with at least one dimension, the threat vectors displayed on a graphical user interface.

An exemplary computer system for identifying corporate risk may be adapted to perform the steps of obtaining corporate data on computer-readable media, the corporate data comprising at least one of internal data and external data, obtaining behavioral corporate data from the corporate data on computer-readable media, the behavioral corporate data comprising at least one event data point, obtaining data indicative of risk-creating behavior from the behavioral corporate data on computer-readable media by evaluating the corporate data against a knowledge-base of characteristic risk-creating behavior, and communicating the data indicative of risk-creating behavior to a user as threat vectors with at least one dimension, the threat vectors displayed on a graphical user interface.

### BRIEF DESCRIPTION OF THE DRAWINGS

The present embodiments are illustrated by way of example and not limitation in the figures of the accompanying drawings, in which like references indicate similar elements.

FIG. 1 illustrates an exemplary embodiment of a computer system.

FIG. 2 illustrates an exemplary computer-implemented method of identifying corporate risk.

FIG. 3 is an exemplary three-dimensional diagram showing a data security incident assessment.

FIG. 4 is an exemplary diagram showing intellectual property risk that stem from a variety of sources in an external business relationships threat vector.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Embodiments disclosed herein may provide methods and systems for managing corporate risk. Corporate risk may arise, for example, from activities by insiders or outsiders, on site or while mobile, which may result in the loss of intellectual property in enterprises. In assessing and prioritizing corporate risk, embodiments disclosed herein may utilize a multitude of variables, including, but not limited to, external factors, key valuation drivers, quantified internal systems data, and operating environment. Utilizing these variables may help develop a value-driven risk profile, which may allow companies to prioritize resources for risk mitigation. For example, external factors, such as elements that may be external to the organization but which may directly impact or affect the organization, or create a risk for the organization, can include partnerships, joint ventures, competitors and third-party vendors that have access to some client data and/or systems. Key valuation drivers may be aspects of an organization's asset or assets that can be used to determine an overall cost valuation of an asset and potential impact to the business operations or brand image when compromised. Internal systems data may be any data that resides on a client's internal system or infrastructure and an operating environment may be any combination of social, economic and, political factors that can affect the activities of an organization.

Additionally, any number of factors may be utilized to generate a security risk assessment. For example, asset criticality, an overall importance to the organization's strategic goals and objectives may be evaluated. An asset's exposure to risk may also be studied. This can include a degree of exposure an asset has to people, processes and practice, the degree of exposure to network infrastructure, adversarial intent and capability and frequency of exposure. Controls and countermeasures that an organization has, including a measure of a methods adequacy for risk mitigation can be further assessed. Severity or an impact to an asset can be assessed to determine the magnitude of impact a vulnerability may have to an asset. Additionally, a cost valuation may be made. The cost valuation can assess the financial impact to an organization's overall valuation should from compromise occur.

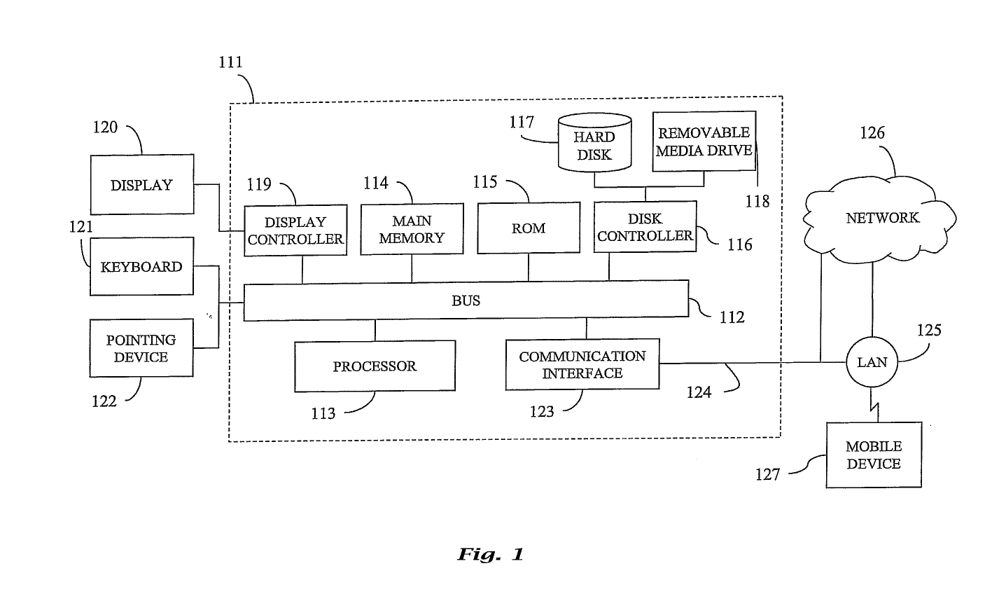

FIG. 1 illustrates a computer system 111 upon which an embodiment of the present invention may be implemented. The computer system 111 may include a bus 112 or other communication mechanism for communicating information, and a processor 113 coupled with the bus 112 for processing the information. The computer system 111 also may include a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 may further include a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 may also include a disk controller 116 coupled to the bus 112 to control one or more storage devices for storing information and instructions, such as a magnetic hard disk 117, and a removable media drive 118 (e.g., floppy disk drive, flash memory drive, read-only compact disc drive, read/write compact disc drive, compact disc jukebox, tape drive, and removable magneto-optical drive). The storage devices may be added to the computer system 111 using an appropriate device interface, including, for example, a small computer system interface (SCSI), integrated device electronics (IDE), enhanced-IDE (E-IDE), direct memory access (DMA), ultra-DMA, a serial port connection, a parallel port connection, USB, IEEE 1394 (FireWire), Bluetooth, Wi-Fi, or any other type of connection or interface known in the art.

The computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer user. The computer system may include input devices, such as a keyboard 121 and a pointing device 122, for interacting with a computer user and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 may perform a portion or all of the processing steps of exemplary embodiments of the invention in response to the processor 113 executing one or more sequences of one or more instructions contained in a memory, such as the main memory 114. Such instructions may be read into the main memory 114 from another computer-readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 may include at least one computer-readable medium or memory for holding instructions programmed according to the teachings of exemplary embodiments of the invention and for containing data structures, tables, records, or other data described herein. Examples of computer-readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer-readable media, exemplary embodiments of the present invention may include software for controlling the computer system 111, for driving a device or devices for implementing exemplary embodiments of the invention, and for enabling the computer system 111 to interact with a human user. Such software may include, but is not limited to, device drivers, operating systems, development tools, and applications software. Such computer-readable media may further include the computer program product of exemplary embodiments of the present invention for performing all or a portion (if processing is distributed) of the processing performed in implementing exemplary embodiments of the invention.

The computer code devices of exemplary embodiments of the present invention may be any interpretable or executable code mechanism, including but not limited to scripts, interpretable programs, dynamic link libraries (DLLs), Java classes, and complete executable programs. Moreover, parts of the processing of exemplary embodiments of the present invention may be distributed for better performance, reliability, and/or cost.

The term “computer-readable medium” as used herein refers to any medium that may participate in providing instructions to the processor 113 for execution. A computer-readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media may include dynamic memory, such as the main memory 114. Transmission media may include coaxial cables, copper wire and fiber optics, including the wires that make up the bus 112. Transmission media also may also take the form of acoustic or light waves, such as those generated during radio wave and infrared data communications. Transmission may be accomplished using, for example, a serial port connection, a parallel port connection, USB, IEEE 1394 (FireWire), Bluetooth, WI-Fi, or any other type of connection or interface known in the art.

Various forms of computer-readable media may be involved in carrying out one or more sequences of one or more instructions to processor 113 for execution. For example, the instructions may initially be carried on a magnetic disk of a remote computer. The remote computer can load the instructions for implementing all or a portion of exemplary embodiments of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 may carry the data to the main memory 114, from which the processor 113 may retrieve and execute the instructions. The instructions received by the main memory 114 may optionally be stored on storage device 117 or 118 either before or after execution by processor 113.

The computer system 111 may also include a communication interface 123 coupled to the bus 112. The communication interface 123 may provide a two-way data communication coupling to a network link 124 that may be connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links, using, for example, Wi-Fi or Bluetooth, may also be implemented. In any such implementation, the communication interface 123 may send and receive electrical, electromagnetic or optical signals that may carry digital data streams representing various types of information.

The network link 124 typically may provide data communication through one or more networks to other data devices. For example, the network link 124 may provide a connection to another computer or remotely located presentation device through a local network 125 (e.g., a LAN) or through equipment operated by a service provider, which may provide communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of exemplary embodiments of the invention may include data transmission and Internet-related activities. See Preston Gralla, How the Internet Works, Ziff-Davis Press (1996), which is hereby incorporated by reference into this patent application. Still other aspects of exemplary embodiments of the invention may utilize wireless data transmission, such as those described in U.S. Pat. Nos. 6,456,645, 5,818,328 and/or 6,208,445, all of which are hereby incorporated by reference into this patent application. In still other aspects, data may be stored or acquired from any source of location, including cloud architecture.

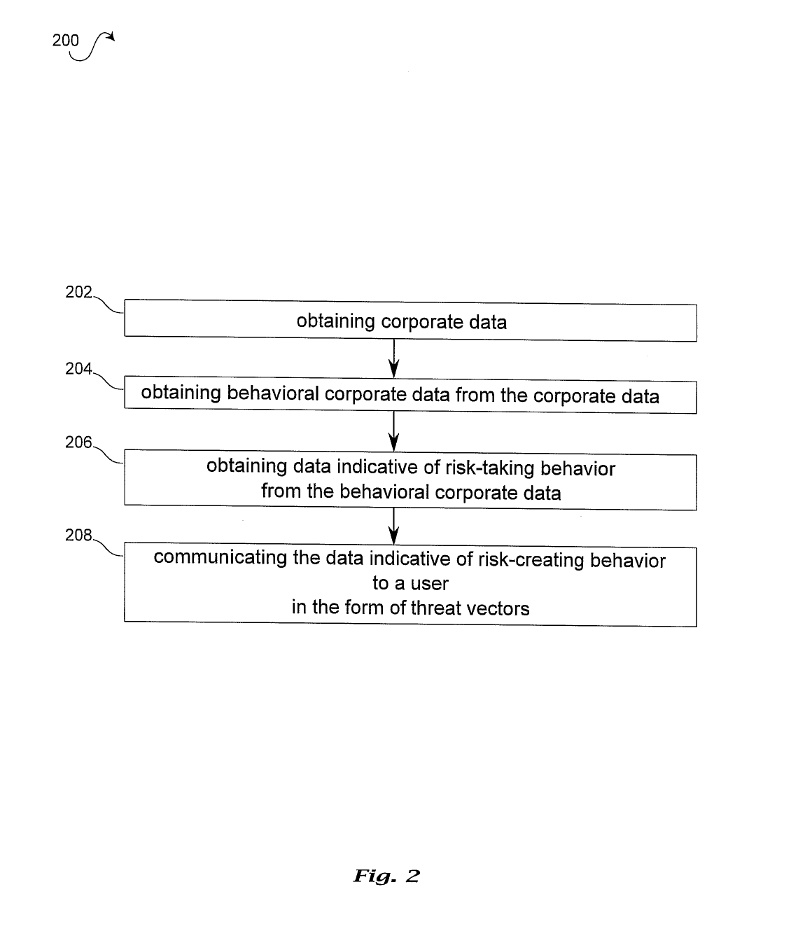

FIG. 2 shows an exemplary computer-implemented method 200 of identifying corporate risk, which may include obtaining corporate data at step 202, obtaining behavioral corporate data from the corporate data at step 204, obtaining data indicative of risk-creating behavior from the behavioral corporate data at step 206, and communicating the data indicative of risk-creating behavior to a user in the form of threat vectors at step 208. Risks to corporate valuation may stem from data about the interactions among, for example, operations, business processes, governance policies, technology systems and relationships. Data may be obtained on or from computer-readable media, from cloud architecture or from any other source known or desired.

At step 202, corporate data may be obtained by computer-readable media. Corporate data may be internal data generated by existing corporate business processes and technology systems, and/or external data from external data sources. This data may then be quantified so as to provide for some baseline values. Further, corporate business processes, technology systems, and external data sources may be elements of a business but, however, may not be indicative of a specific client report or data type. Additionally, external data may include information derived from publically available sources or data stores, subscription-based sources or data stores, or proprietary joint venture or partner sources or data stores. However, corporate data may be collected (in this and other steps) from any available client data, external data sources (including, but not limited to, internet protocol data), news media results and any other desired information that may be pertinent or relevant to an over risk ecosystem evaluation of a client. Then, in some exemplary embodiments, these different sets of data may be analyzed to provide various forms of data visualization graphics, as well utilized in the generation of reports detailing various risks that may be affecting an entity being analyzed.

At step 204, behavioral corporate data may be obtained from the corporate data. Behavioral corporate data may include data regarding, for example, behaviors that occur in the course of business, such as employees interacting with suppliers, suppliers with customers, or customers with partners. Behavioral corporate data may include event data described by categorical variables.

Categorical variables may include, for example, actors, actions, and attendant characteristics. An event may be a singular action or a series of related actions taken by one or several actors. Actors may include, for example, staff employees, joint venture partners, or third-party vendors. An event may include, for example, downloading data from a network, using an RFID badge, or applying for a position.

Categorical variables may have characteristics. For example, an “employee” actor may have characteristics such as “tenure,” “title,” and “gender,” while a “download” event may have characteristics such has “time of day,” “number of megabytes,” and “requesting IP address.”

At step 206, data indicative of risk-creating behavior may be obtained from the behavioral corporate data by evaluating the corporate data against a knowledge-base of characteristic risk-creating behavior. Such an evaluation of corporate data may include any of a variety of steps. For example, various activities of the organization can be examined as they relate to the movement of data. Further, established policies and procedures, as what as what the organization considers normal, typical or routine for business operations may also be studied. These policies and procedures can include, for example, employee activities, partnership engagement, joint venture relationships, collaboration with vendors and other outside sources. After such items are interpreted, a baseline may be established and an awareness and understanding of how an organization operates, the environment in which the organization conducts business and the risk tolerance of the organization may be determined. Then, based on that interpretation and analysis, deviations from the baseline may be more easily and efficiently identified. Potential risks may further be assessed and the organization can be more quickly notified and/or take action to mitigate any potential or real risks.

An event or a series of events in time may be identified as risk-creating behavior. Behavioral corporate data may present corporate risk if, when evaluated against the knowledge-base of characteristic risk-creating behavior, its state or its progression in time conforms to certain states or time patterns indicative of activity that has the potential of compromising the intellectual capital of a firm, to the detriment of the firm's competitive advantage.

At step 208, the data indicative of risk-creating behavior may be communicated to a user in the form of threat vectors. Data indicative of risk-creating behavior may be represented by a multi-dimensional threat vector, adapted to be displayed on a multi-dimensional graphical representation.

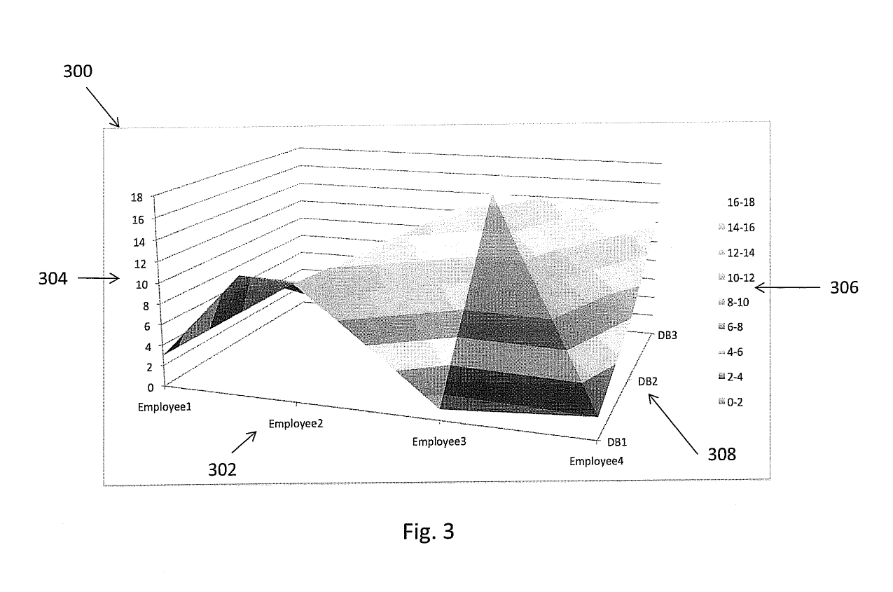

Referring now to exemplary FIG. 3 a graph 300 may be provided to show a threat vector. A first axis 302 of the graph 300 may provide information pertaining to the source of the threat, namely whether a threat is internal or external. A threat may be internal if it originated from firm employees, and may be external if it originated from non-employees. For example, an internal threat may include a threat from a design engineer permitted to use a personal flash drive on a company computer containing valuable engineering data, while an external threat may include a threat stemming from joint venture partners or suppliers' access to privileged information, through local or remote access to employees. In this exemplary embodiment, the first axis 302 may be employees of an organization.

A second axis 304 of the graph 300 may provide information pertaining to the nature of the threat, namely whether a threat is physical or virtual. Physical threats may relate to direct, proximity-based access to people, facilities or infrastructure, while virtual threats may relate to the use of non-physical, remote access, such as, for example, through IT networks. For example, a physical threat may include a threat from a vendor employee with unmanaged access to client facilities, or a threat from a contract maintenance technician that services corporate communications infrastructure. A virtual threat may include a threat from a partner firm employee who, by virtue of working at a joint venture, is granted IT permissions that mirror client employees, or a threat from a former employee whose IT access permissions are not terminated upon his or her departure from a firm.

A third axis 306 of a graph 300 may provide information pertaining to the potential effect of the threat, namely whether a threat is categorized as a threat to innovation, execution or reputation. A threat to innovation may affect future earnings, while a threat to execution may affect current earnings and a threat to reputation may affect value added. For example, a threat in a research and development facility may be categorized as a threat innovation, and thus to future earnings. A same threat in a manufacturing plant or an outside advertising agency may be categorized as a threat to current earnings (i.e. a firm's execution capability), or to brand equity and value created (i.e. a firm's reputation).

Additional axes or indicators, such as 308 on graph 300 may be incorporated into a multi-dimensional graphical representation of threat vectors, as needed to adapt to a dynamic and rapidly changing business environment.

One-dimensional, two-dimensional or three-dimensional projections of a multi-dimensional graphical representation may be generated, as needed for different applications, and as possible when given technological constraints. A three-dimensional model may be suitable for media-rich environments that allow the model to be rotated in real time to facilitate nuanced communication of a firm's current risk posture as a function of all threat vectors, as well as a view of the firm's risk posture over time.

Exemplary FIG. 3 provides one such three-dimensional model. In such an example, both qualitative and quantitative risk assessment tools may be utilized to collect various requests to provide a baseline for the organization or be utilized in compliance or auditing, as desired. Such tools may include, but are not limited to, surveys, risk rating scales, automated log analysis tools, and the like. Outputs from different tools may be utilized in the generation of a risk metric, which are then assigned to one or more of a number of security domains. Such domains can include, but are not limited to, physical security, data security, people, internal business process, external business operations, financial data, travel, and incident response. Such exemplary security domains may then be utilized to quickly and efficiently assess where more significant risk may be present.

Then, based on a change, rate of change, source of change referenced, or other change information, deviations in data may be captured. For example, after a baseline is established, the downloading behavior of an employee may change beyond what is considered a “normal” or acceptable level from the baseline. In such an exemplary embodiment, a baseline may be made where a normal amount of download activity from a predetermined database is five downloads a day, with the understanding that most members of the organization do not begin downloading data until they have worked on a specific matter for about two months. Then, if it is determined that a long term (i.e. longer than two months) employee begins to consistently, routinely or singularly, begin downloading more than 5 times during a given time period, or if a new (i.e. less than two months employee) begins downloading any data in a given time period, it can be quickly and efficiently determined that this activity varies from the baseline as these would be interpreted as deviations from the baseline. Then, any of a change, rate of change (for example percentage of overall download volume in this example), and source of change (either a change in the employee or a change in the system, data, or database being accessed by the employee) can be monitored or utilized to assess and determine potential risks to the organization, the organization's infrastructure, and the organization's property.

With respect to exemplary FIG. 3, the first axis 302 may be utilized to show employees and risk-related factors may be shown on the other axes. In this example, four employees may be assessed. The second axis 304 can be representative with the amount of time an employee has worked on a certain matter. Per the above example, when an employee has been working on a matter for less than two months, that employee should not have any downloads, for examples from the databases 308 (DB1, DB2, DB3). The third axis 306 may show the amount of downloads, and from which location, that an employee made during a specified time period.

Thus, from this example, if the baseline is known to be five downloads per day, each of the employees' behaviors and actions can be analyzed to determine which employee deviates from the baseline, where the deviations are occurring and when the deviations occur. This data can then be utilized to determine which, if any, parties are creating risk for the organization.

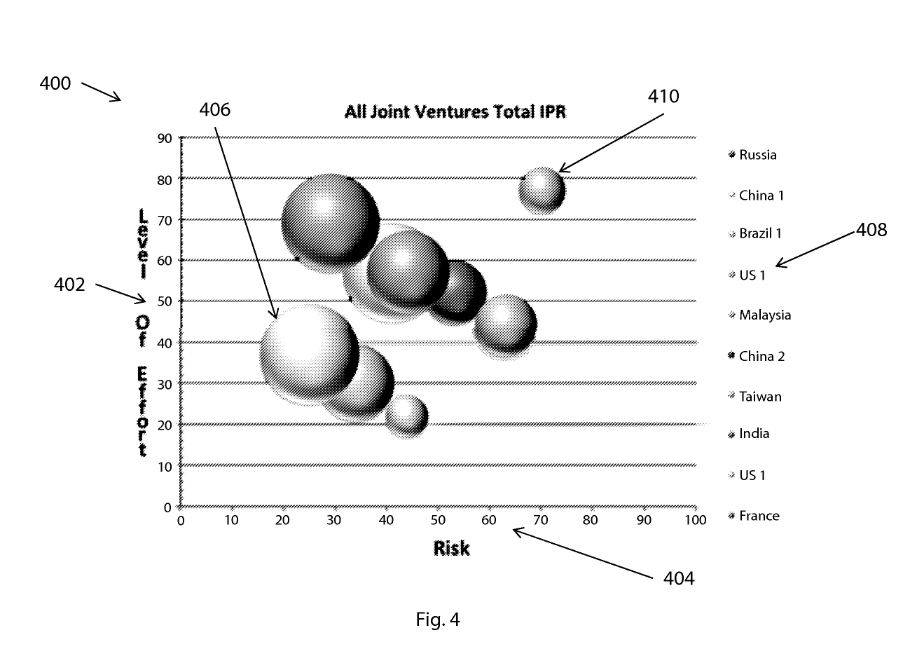

Exemplary FIG. 4 is a graphical diagram 400 showing a composite view of intellectual property risk that may stem from risk-creating behaviors, events or actors in an external business relationships threat vector. Such an exemplary external business relationship could be joint venture. The exemplary x-axis 402 may show risk exposure of a client's critical assets in the external business relationship. Such assets may include, but are not limited to, people, programs, physical or virtual access to data or information, legal agreements, and the like. The y-axis 404 can illustrate a level of effort that used to remedy any identified risks. This representation may further include an emphasis or highlighting of what may have the greatest possible return on investment for expenditure in enterprise security. This can further enable an alignment of risk reduction investments with business strategies and priorities.

Still referring to exemplary FIG. 4, the size or weight of a bubble 406 may be related to cost valuation of underlying assets and the sensitivity of the assets to risk-creating behaviors, events or actors. Additionally, in some exemplary embodiments, such as for certain distributed enterprise clients, bubbles, such as bubbles 406 and 410, may be shaded, colored or otherwise depicted in an individual fashion in order to show specific locations that may present a greater security risk from external partnerships.

In the example shown in FIG. 4, the bubble 406 may have a moderate level of effort needed for a low level of risk for a very significant asset cost valuation. As indicated by key 408, bubble 406 may be associated with a first joint venture with a partner from the U.S. Alternatively, bubble 410 may reflect a higher level of effort to achieve only a moderate level of risk for a less significant asset cost valuation. As shown in key 408, bubble 410 may be associated with a joint venture with a partner from Brazil.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for identifying corporate risk, implemented on a computer system, the method comprising:
obtaining corporate data on computer-readable media, the corporate data comprising at least one of quantifiable internal data and external data;
obtaining behavioral corporate data from the corporate data on computer-readable media, the behavioral corporate data comprising at least one event data point;
obtaining data indicative of risk-creating behavior from the behavioral corporate data on computer-readable media by evaluating the corporate data against a knowledge-base of characteristic risk-creating behavior; and
providing an output showing the data indicative of risk-creating behavior to a user as threat vectors with at least one dimension, the threat vectors displayed on a graphical user interface.

2. The method for identifying corporate risk of claim 1, wherein the internal data comprises data generated by existing corporate business processes and technology systems.

3. The method for identifying corporate risk of claim 1, wherein each of the at least one event data point comprises at least one categorical variable, the at least one categorical variable comprising at least one of an actors variable, an actions variable and an attendant characteristics variable.

4. The method for identifying corporate risk of claim 1, wherein the at least one dimension pertains to at least one of a source of a threat, a nature of a threat and a potential effect of a threat.

5. The method for identifying corporate risk of claim 4, wherein a dimension pertaining to a source of a threat indicates whether the threat is internal or external.

6. The method for identifying corporate risk of claim 4, wherein a dimension pertaining to a nature of a threat indicates whether the threat is physical or virtual.

7. The method for identifying corporate risk of claim 4, wherein a dimension pertaining to a potential effect of a threat indicates whether the threat is a threat to innovation, a threat to execution or a threat to reputation.

8. A computer system for identifying corporate risk, adapted to perform the steps of:
obtaining corporate data on computer-readable media, the corporate data comprising at least one of quantifiable internal data and external data;
obtaining behavioral corporate data from the corporate data on computer-readable media, the behavioral corporate data comprising at least one event data point;
obtaining data indicative of risk-creating behavior from the behavioral corporate data on computer-readable media by evaluating the corporate data against a knowledge-base of characteristic risk-creating behavior; and
communicating the data indicative of risk-creating behavior to a user as threat vectors with at least one dimension, the threat vectors displayed on a graphical user interface.

9. The computer system for identifying corporate risk of claim 8, wherein the internal data comprises data generated by existing corporate business processes and technology systems.

10. The computer system for identifying corporate risk of claim 8, wherein each of the at least one event data point comprises at least one categorical variable, the at least one categorical variable comprising at least one of an actors variable, an actions variable and an attendant characteristics variable.

11. The computer system for identifying corporate risk of claim 8, wherein the at least one dimension pertains to at least one of a source of a threat, a nature of a threat and a potential effect of a threat.

12. The computer system for identifying corporate risk of claim 8, wherein a dimension pertaining to a source of a threat indicates whether the threat is internal or external.

13. The computer system for identifying corporate risk of claim 8, wherein a dimension pertaining to a nature of a threat indicates whether the threat is physical or virtual.

14. The computer system for identifying corporate risk of claim 13, wherein a dimension pertaining to a potential effect of a threat indicates whether the threat is a threat to innovation, a threat to execution or a threat to reputation.
